(19) United States
(12) Patent Application Publication
(10) Pub. No.: US 2012/0050830 A1
(43) Pub. Date: Mar. 1, 2012

(54) DIGITAL HOLOGRAM IMAGE DISPLAY DEVICE

(76) Inventors: Minsung YOON, Kyungbuk (KR); Guensik Lee, Seoul (KR)

(21) Appl. No.: 13/158,211

(22) Filed: Jun. 10, 2011

(30) Foreign Application Priority Data
Aug. 31, 2010 (KR) 10-2010-0084911

(51) Int. Cl. G03H 1/12

(52) U.S. Cl. 359/11

(57) ABSTRACT

The present disclosure relates to a digital hologram display device in which the 0^{th} diffraction component is removed for optimizing the reproduction and replay of the three-dimensional hologram video data. The present disclosure suggests a digital hologram image display device comprising: a pattern generator generating holography interference patterns; a spatial light modulator receiving the holography interference patterns from the pattern generator and represent the holography interference patterns; a light source positioning at one side of the spatial light modulator and illuminating a reference beam to the spatial light modulator; an optical device controlling the reference beam to be raditated onto a whole surface of the spatial light; and a diffusion sheet having at least 20% of Haze value and disposed between the light source and the spatial light modulator.

This application claims the priority benefit of Korea Patent Application No. 10-2010-0084911 filed on Aug. 31, 2010, which is incorporated herein by reference for all purposes as if fully set forth herein.

### BACKGROUND OF THE INVENTION

1. Field of the Invention

The present disclosure relates to a digital hologram dispay device for reproducing/replaying the digital hologram video data for playing the three dimensional video image. Especially, the present disclosure relates to a digital hologram display device in which the 0^{th} diffraction component is removed for optimizing the reproduction and replay of the three-dimensional hologram video data.

2. Discussion of the Related Art

Recently, many technologies and reasearches for making and reproducing the 3D (Three Dimensional) image/video are actively developed. As the media relating to the 3D image/video is a new concept for virtual reality, it can improve the visual information better, and it will lead the next generation display devices. The conventional 2D image system merely suggests the image and video data projected into plan view, but the 3D image system can provide the full real image data to the viewer. So, the 3D image/video technologies are the true image/video technologies.

Typically there are three methods for reproducing 3D image/video; the stereoscopy method, the holography method and the integral imaging method. Among them, the holography method is the most ideal method because it has an excellent visual autostereoscopic property without any fatigue of observer.

To produce a recording of the phase of the light wave at each point in an image, holography uses a reference beam which is combined with the light from the scene or object (the object beam). If these two beams are coherent, optical interference between the reference beam and the object beam, due to the superposition of the light waves, produces a series of intensity fringes that can be recorded on standard photographic film. These fringes form a type of diffraction grating on the film, which is called the hologram. The central goal of holography is that when the recorded gratng is later illuminated by a substitute reference beam, the original object beam is reconstructed (or reproduced), producing a 3D image/video.

There is a new development of the computer generated holography (or CGH) that is the method of digitally generaling holographic interference patterns. A holographic image can be generated e.g. by digitally computing a holographic interference pattern and printing it onto a mask or film for subsequent illumination by suitable coherent light source. the holographic image can be brought to life by a holographic 3D display, bypassing requirement to fabricate a “hardcopy” of the holographic interference pattern each time.

Computer-generated holograms have the advantage that the objects which one wants to show do not have to possess any physical reality at all. If holographic data of existing objects is generated optically, but digitally recorded and processed, and brought to display subsequently, this is termed CGH as well. For example, a holographic interference pattern is generated by a computer system and it is sent to a spatial light modulator such as LCSML (Liquid Crystal Spatial Light Modulator), then the 3D image/video corresponding to the holographic inferference pattern is reconstructed/reproduced by illuminating a reference beam to the spatial light modulator. FIG. 1 is the structural drawing illustrating the digital holography image/video display device using the computer-generated holography according to the related art.

Referring to FIG. 1, the computer 10 generates a holographic interference pattern of an image/video data to be displayed. The generated holographic interference pattern is sent to a SLM 20. The SLM 20, as a transmitive liquid crystal display device, can represent the holographic interference pattern. At one side of the SLM 20, a laser source 30 for generating a reference beam is located. In order to collimate the reference beam 90 from the laser source 30 onto the whole surface of the SLM 20, an expander 40 and a lens system 50 can be disposed, sequentially. The reference beam 90 out from the laser source 30 is illuminated to one side of the SLM 20 passing through the expander 40 and the lens system 50. As the SLM 20 is a transmittive liquid crystal display device, a 3D image/video corresponding to the holography interference pattern will be reconstructed/reproduced at the other side of the SLM 20.

At this time, there are some components of the reference beam 90 which is not diffracted by the holographic interference pattern but just passing through the holographic interference pattern. These components are called as the “DC component” or the “0^{th} diffraction component.” The 0^{th} diffraction component passing through the holographic interference pattern is superimposed with the reproduced images and causes the deteriorated image/video quality. Upto now, there are some researches for eliminating the 0^{th} diffraction component in the digital holography.

For example, there is one method in which the 0^{th} diffraction component is reduced by diffusing it using a concaved lens in front of the SLM (OpticsInfoBase '09, 7 “Experimental modules covering imaging, dffraction, Fourier optics and polarization based on a liquid-crystal cell SLM). However, the reproduced image may be smaller than original image. Another method is that the intensity of the 0^{th} diffraction component is lowered by using a polarizer in front of the SLM (Otics Express '08, 9 “Hologram optimization for SLM-based reconstruction with regard to polarization effects”). In this case, the intensity of the reproduced image also lowered. For still another method, the 0^{th} diffraction component can be eliminated by mechanical methods. However, in any cases, the reproduced image can be damaged, or these methods cannot be available to the large 3D images at all.

### SUMMARY OF THE INVENTION

In order to overcome the above mentioned drawbacks, the purpose of the present disclosure is to suggest a digital hologram image display device having enhanced 3D image quality by eliminating the 0^{th} diffraction component effectively.

In order to accomplish the above purpose, the present disclosure suggests a digital hologram image display device comprising: a pattern generator generating holography interference patterns; a spatial light modulator receiving the holography interference patterns from the pattern generator and represent the holography interference patterns; a light source positioning at one side of the spatial light modulator and illuminating a reference beam to the spatial light modulator; an optical device controlling the reference beam to be collimated onto a whole surface of the spatial light; and a diffusion sheet having at least 20% of Haze value and disposed between the light source and the spatial light modulator.

The diffusion film has at most 50% of Haze value.

The diffusion film has Haze value selected one of 30%˜40%.

The diffusion film is disposed between the optical device and the light source.

The diffusion film is disposed at next to the spatial light modulator.

The diffusion film is disposed between the optical device and the spatial light modulator.

The optical device comprises: an expander enlarging the cross-sectional area of the reference beam; and a lens system controlling the enlarged cross-sectional area of the reference beam to be corresponding to the whole surface of the spatial light modulator.

The spatial light modulator includes a liquid crystal display panel having: a transparent upper substrate and a transparent lower substrate facing each other; and a liquid crystal layer disposed between the transparent upper substrate and the transparent lower substrate.

The light source includes at least one of laser diode and a collimated LED which are disposed at one side of the liquid crystal display panel, and the optical device includes an optical fiber having a light inlet connecting to the light source and a light outlet facing to the spatial light modulator.

The device further comprises: an optical sheet between the spatial light modulator and the diffusion film.

In the digital hologram image display device according to the present disclosure, the 0^{th} diffraction component can be selectively and effectively eliminated. Especially, without any distortion or deformation of the 3D image/video wanted to be reproduced, the intensity of the 0^{th} diffraction component can be lowered so that clean 3D image/video can be acquired using a simple digital hologram image display device according to the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is the structural drawing illustrating the digital holography image/video display device using the computer generated holography according to the related art.

FIG. 2 is the structural drawing illustrating a digital holography image/video display device using the computer-generated holography according to the present disclosure.

FIGS. 3A to 3D are 3D graphs illustrating the qualities of the image/video according to the Haze value of the diffusion film according to the present disclosure.

FIG. 4 is the structural drawing illustrating a digital holography image/video display device using a transmittive liquid crystal display device as a spatial light modulator of the computer-generated holography according to the present disclosure.

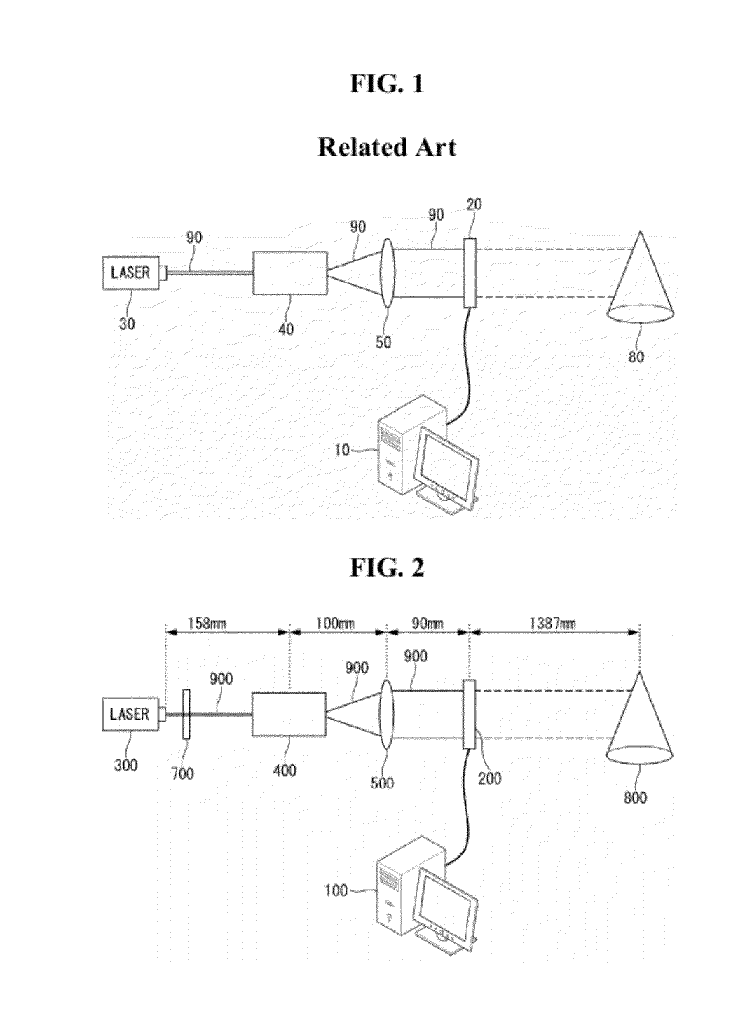

### DETAILED DESCRIPTION OF THE ILLUSTRATED EMBODIMENTS

Referring to attached figures including FIGS. 2 to 4, we will explain preferred embodiments of the present disclosure. FIG. 2 is the structural drawing illustrating a digital holography image/video display device using the computer-generated holography according to the present disclosure.

Referring to FIG. 2, a digital hologram image display device comprises a computer 100 for generating a holographic interference pattern of a 3D image/video data, and a SLM 200 receiving the holographic inference pattern from the computer 100 and representing the holographic interference pattern thereon. A light source 300 for generating a reference beam 900 is located at one side of the SLM 200. The reference beam 900 would preferably be a coherent light. Therefore, the light source 300 would include a laser source or a collimated LED. Between the light source 300 and the SLM 200, an expander 400 and a lens system 500 are disposed sequentially for illuminating the reference beam to the whole surface of the SLM 200.

For example, the light source 300 and the expander 400 may be apart 158 mm from each other, and the expander 400 and the lens system 500 can be apart 100 mm from each other. Furthermore, the lens system 500 and the SLM 200 can be apart 90 mm from each other. The coherent light radiated from the light source 300 can be a reference beam 900 having a large diameter by the expander 400. The lens system 500 guides the reference beam 900 onto the whole surface of the SLM 200. In this case, the reproduced 3D image/video 800 can be displayed at the air apart 1397 mm from the SLM 200.

In order to reduce the intensity of the 0^{th} diffraction component of the reference beam 900 which is not diffracted at the SLM 200 but passing through the SLM 200, a diffusion film 700 is further comprised between the light source 300 and the 3D image/video 800 at proper position. More preferably, the diffusion film 700 can be located between the SLM 200 and the 3D image/video 800, between the lens system 500 and the expander 400, or between the light source 300 and the expander 400.

The diffustion film 700 diffuses an incident light. Referring to the Equation 1, when a light passes through the plane area, the total transmittance is defined as a ratio of the transmissive light amount to the incident light amount to the plane area. The total transmittance includes the parallel transmittance and the diffused transmittance. The parallel transmittance is the amount of light which enters into the plane area and then transmits within a predetermined angle to the incident angle. The diffused transmittance is the amount of light which enters into the plane area and then transmits having a passing angle over the predetermined angle.

$$\begin{matrix}Total Transmittance ( \% ) = ( \frac{Transmitted Light}{Incident Light} ) \times 100 \\ = Parallel Transmittance ( T p ) + \\ Diffuesed Transmittance ( T d )\end{matrix} \qquad [ Equation 1 ]$$

The diffusion film (or diffusion plate) is an optical film having the diffusion-transittive property. Referring to the Equatio 2, the Haze value representing the diffusing ability of the diffusing film 700 is defined as the percentage of the diffused transmittance to the total transmittance.

Haze (%)=(Td/Ttotal)×100 [Equation 2]

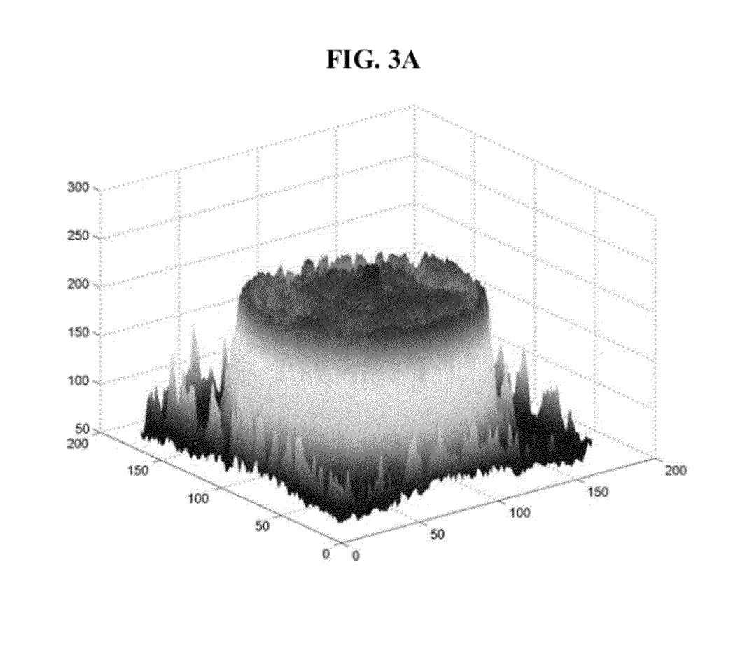

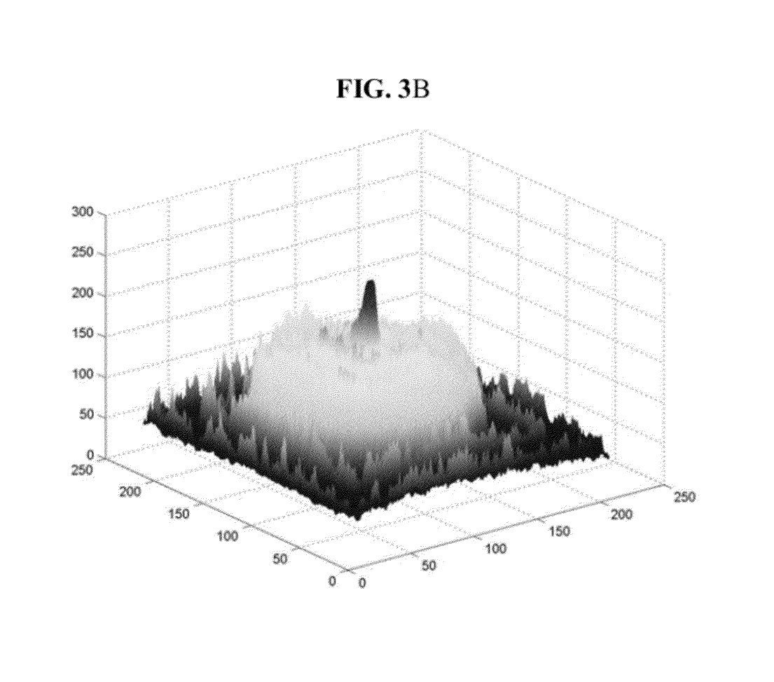

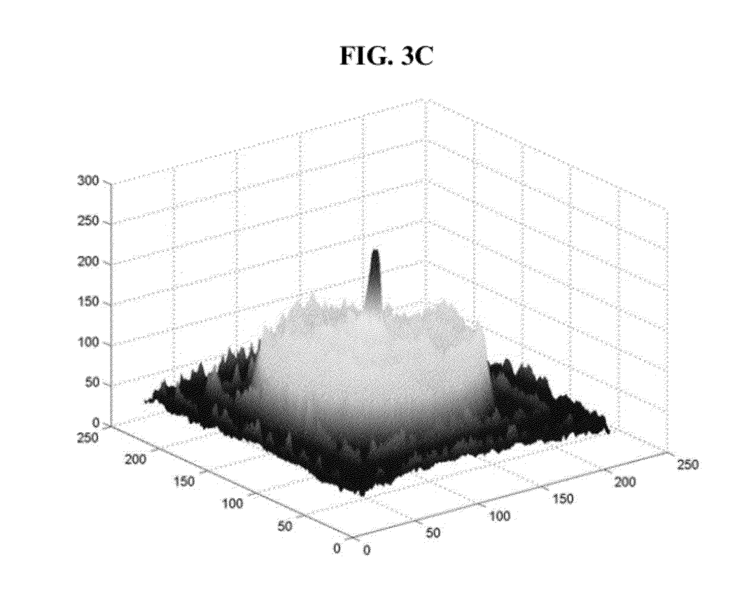

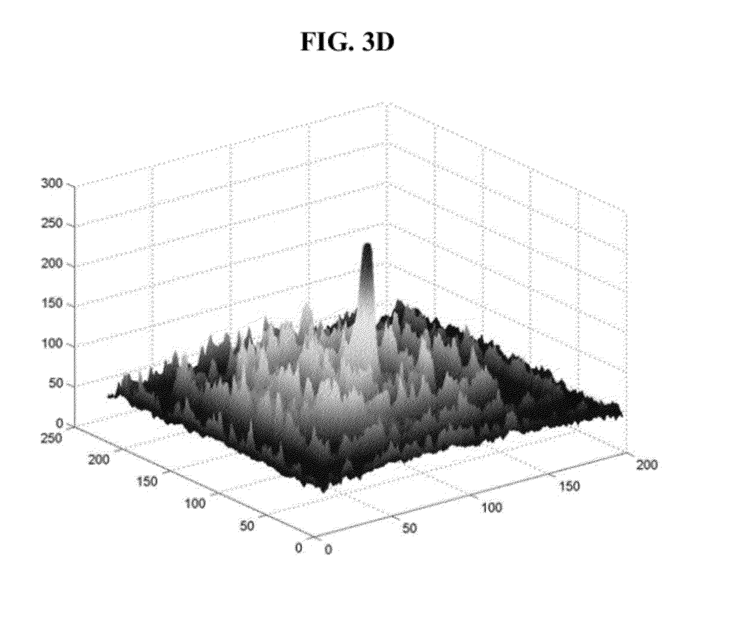

FIGS. 3A to 3d are 3D graphs illustrating the qualities of the image/video according to the Haze value of the diffusion film according to the present disclosure. FIG. 3A is a 3D graph showing the intensity of the reproduced image/video without diffusion film 700. FIG. 3A is a 3D graph illustrating the case in which the 0^{th} diffraction component is not eliminated at all so that the 0^{th} diffraction component has much stronger intensity than the reproduced image/video. That is, the correct 3D image/video cannot be properly observed.

FIG. 3B is a 3D graph illustrating the intensity of the image/video wanted to be reproduced in which the diffusion film 700 having 0% of Haze value is located right in front of the light source 300. According to the Equation 2, 0% of Haze may the same situation of no diffusion film 700. However, the case there is no diffusion film and the case there is a diffusion film of which Haze is 0% are totally different. As the diffused transmittance is defined as the amount of light diffused over a predetermined anlge to the incident angle, that there is a diffustion film 700 means the incident light is diffused somewhat at least. That is, in the case that the diffusion film 700 having 0% Haze is disposed in front of the light source 300, the intensity of the 0^{th} diffraction component is reduced a lot so it is possible for the observer to aware what is the 3D image/video. FIG. 3C is a 3D graph illustrating the intensity of the image/video wanted to be reproduced in which the diffusion film 700 having 20% of Haze is located in front of the light source 300. The intensity of the 0^{th} diffraction component is remarkably reduced so it is possible for the observer to be clearly aware of the 3D image/video scene. Finally, FIG. 3D is a 3D graph illustrating the intensity of the image/video wanted to be reproduced in which the diffusion film 700 having 32% of Haze is located right in front of the light source 300. Most of all 0^{th} diffraction components are eliminated so it is possible for the observer to completely enjoy the 3D image/video as the original one.

According to the preferred embodiment of the present disclosure, the digital hologram image display device comprises a diffusion film 700 having 30% or more Haze between the light source 300 and the output image 800. As a result, it is possible to selectively eliminate the strength of the 0^{th} diffraction component only. Especially, as the coherent property of the reference beam 900 has problem when the Haze is too high, the Haze would prefereably be less than 50%. In the best mode, the diffusion film 700 of which Haze value is selected one of 30˜40% is disposed between the light source 300 and the expander 400 to get the best quality of reproduced image/video.

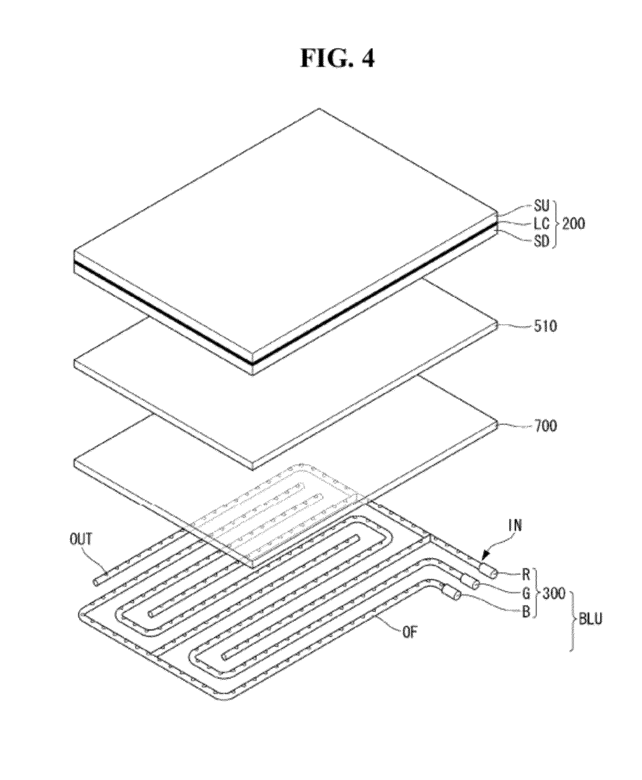

Hereinafter, we will explain one example in which a 3D image display device using a transmittive liquid crystal display device according to the present disclosure. FIG. 4 is the structural drawing illustrating a digital holography image/video display device using a transmittive liquid crystal display device as a spatial light modulator of the computer generated holography according to the present disclosure.

Referring to FIG. 4, the SLM 200 is a transmittive liquid crystal display device. That is, the SLM 200 comprises an upper substrate SU and a lower substrate SD, which include transparent glass substrate and are facing each other, and liquid crystal layer LC disposed therebetween. The SLM 200 receives holography interference patterns from the computer 100 or a video processor (not shown), and represents them on the display area. The upper substrate SU and the lower substrate SD can have a color filter layer and a plurality of thin film transistors, respectively.

Under the SLM 200, a backlight unit BLU having a light source 300 and an optical fiber OF is disposed. The light source 300 may include a set of laser diodes having a red laser diode R, a green laser diode G and a blue laser diode B. Otherwise, the light source 300 may include a set of collimated LEDs having a red, green and blue collimated LEDs. In other examples, the light source 300 may include the combination of other color light source than red, green and/or blue, or it may include single light source such as a white laser diode or a white collimated LED. In this embodiment, the light source 300 is a set of red, green and blue laser diodes, in covenience.

In order to guide the reference beam radiated from the light source 300 to the bottom surface of the SLM 200 evenly, an optical fiber OF can be used. For example, laser diodes R, G and B are disposed at one side of the backlight unit BLU. Using the optical fiber OF, the laser beam illuminated from the laser diodes R, G and B can be guided in such a manner that the laser beams are distributed on the bottom surface of the SLM 200. To do so, the optical fiber OF would run to pass over the whole plane area of the SLM 200. Furthermore, some portions of clad covering the core of the optical fiber OF are removed to form a plurality of light outlets for emittting the laser beam so that it is possible to illuminate the coherent light overall of the surface of the SLM 200.

Comparing with FIG. 3, in the digital hologram image display device shown in FIG. 4, the optical fiber OF plays role of expander which distributes the reference beam to the plane surface of the SLM 200. Therefore, in the FIG. 4, an optical sheet 510 acting as the lens system 500 in FIG. 3 may be further included. That is, the optical sheet 510 can be inserted between the SLM 200 and the optical fiber OF to make the reference beam correspond to the plane surface of the SLM 200 and be coherent.

Furthermore, a diffusion film 700 of which Haze value is selected one of 30˜40% for eliminating the 0^{th} diffraction component can be disposed between the upside of the light outlets OUT of the optical fiber OF and the bottom surface of the SLM 200. More preferably, the diffusion film 700 is disposed between the optical sheet OF and the optical sheet 510. Othewise, even though not shown in figure, by forming the diffusion film 700 as small films, they may be disposed at the light inlets IN where the laser diodes R, G and B are contact with the optical fiber OF, so that the coherent light not causing the 0^{th} diffraction component can incident into the optical fiber OF.

In the digital hologram image display device structured according to the present disclosure, the holography interference patterns are represented on the SLM 200, the liquid crystal display panel. By illuminating the reference beam form the light source 300 of laser diodes R, G and B to the liquid crystal display panel, the 3D image/video can be reproduced at the air above the SLM 200. Especially, thanks to the diffusion film 700 of which Haze value is selected one of 30˜40%, the 0^{th} diffraction component can be eliminated or reduced and then excellent quality of 3D image/video can be acquired.

While the embodiment of the present invention has been described in detail with reference to the drawings, it will be understood by those skilled in the art that the invention can be implemented in other specific forms without changing the technical spirit or essential features of the invention. Therefore, it should be noted that the forgoing embodiments are merely illustrative in all aspects and are not to be construed as limiting the invention. The scope of the invention is defined by the appended claims rather than the detailed description of the invention. All changes or modifications or their equivalents made within the meanings and scope of the claims should be construed as falling within the scope of the invention.

What is claimed is:

1. A digital hologram image display device comprising:
a pattern generator generating holography interference patterns;
a spatial light modulator receiving the holography interference patterns from the pattern generator and represent the holography interference patterns;
a light source positioning at one side of the spatial light modulator and illuminating a reference beam to the spatial light modulator;
an optical device controlling the reference beam to be collimated onto a whole surface of the spatial light; and
a diffusion sheet having at least 20% of Haze value and disposed between the light source and the spatial light modulator.

2. The device according to claim 1, wherein the diffusion film has at most 50% of Haze value.

3. The device according to claim 1, wherein the diffusion film has Haze value selected one of 30%˜40%.

4. The device according to claim 1, wherein the diffusion film is disposed between the optical device and the light source.

5. The device according to claim 1, wherein the diffusion film is disposed at next to the spatial light modulator.

6. The device according to claim 1, wherein the diffusion film is disposed between the optical device and the spatial light modulator.

7. The device according to claim 1, wherein the optical device comprises:
an expander enlarging the cross-sectional area of the reference beam; and
a lens system controlling the enlarged cross-sectional area of the reference beam to be corresponding to the whole surface of the spatial light modulator.

8. The device according to claim 1, wherein the spatial light modulator includes a liquid crystal display panel having:
a transparent upper substrate and a transparent lower substrate facing each other; and
a liquid crystal layer disposed between the transparent upper substrate and the transparent lower substrate.

9. The device according to claim 8, wherein the light source includes at least one of laser diode and a collimated LED which are disposed at one side of the liquid crystal display panel, and
the optical device includes an optical fiber having a light inlet connecting to the light source and a light outlet facing to the spatial light modulator.

10. The device according to claim 9, further comprising:
an optical sheet between the spatial light modulator and the diffusion film.
